(19) United States
(12) Patent Application Publication
(10) Pub. No.: US 2024/0219897 A1
(43) Pub. Date: Jul. 4, 2024

(54) Control System for at Least One Receiving Device in Safety-Critical Applications

(71) Applicant: Robert Bosch GmbH, Stuttgart (DE)

(72) Inventors: Erhart Lederer, Rutesheim (DE); Panagiotis Kosioris, Urbach (DE); Daniel Tuchscherer, Fellbach (DE); Frederik Morlok, Wildberg Gueltlingen (DE); Jaroslaw Topp, Renningen (DE); Frank Traenkle, Erdmannhausen (DE)

(21) Appl. No.: 18/570,989

(22) PCT Filed: Jun. 14, 2022
(86) PCT No.: PCT/EP2022/066119

§ 371 Date: Dec. 15, 2023

(30) Foreign Application Priority Data
Jun. 16, 2021 (DE) 10 2021 206 133.8

(51) Int. Cl. G05B 23/02

(52) U.S. Cl. CPC G05B 23/0216

(57) ABSTRACT

A control system for at least one receiving device includes at least one input interface, a plurality of control functions, a self-check logic unit, at least one cross-check logic unit, and at least one output interface. The at least one input interface is configured to read in an input to be reacted to by controlling the receiving device. The plurality of control functions are each configured to determine output data for the actuator from an input which has been read in. The self-check logic unit is for each control function and is configured to detect a malfunction of the control function. The at least one cross-check logic unit is configured to check whether output data determined by a control function are consistent with (i) output data determined by another control function, (ii) internal information from the other control function, and/or (iii) an input used by the other control function.

### PRIOR ART

Many technical systems are safety critical in the sense that in the event of a malfunction, serious property damages or even personal injury can occur. An example of this are systems that control a vehicle driving in a fully or partially automated manner.

In order to reduce the likelihood of malfunctions, a monitoring system in accordance with DE 10 2019 201 491 A1 can, for example, be added to a control function for a vehicle, the monitoring system independently checking the interventions proposed by the control function with regard to safety requirements. However, control functions can also be designed redundantly, for example, with multiple redundancies. For example, if three nominally identical, independent control functions are present, a malfunction of one of these control functions can be clearly identified, for example according to a majority principle, provided that the input data and the output data as well as the states of the three independent control functions are synchronized.

### DISCLOSURE OF THE INVENTION

A control system for at least one receiving device has been developed in the context of the invention. This receiving device can in particular be an actuator, for example. However, in an overall system for at least partially automated driving of a vehicle in traffic, the receiving device can also be, for example, an intermediate link in a chain of action that generates output data as input data for one or more other systems. For example, the control system may generate target lane curves for autonomous driving that are further processed by downstream motion control systems. For example, the motion control system can also be constructed like the control system described herein and can generate control signals for the actuator. Thus, an overall system for at least partially automated driving can include multiple instances of the control system described herein.

The control system comprises at least one input interface which is designed to read an input, to be reacted to via a controlling of the receiving device. The input can, in particular, represent a state of a technical system to which the receiving device to be controlled belongs, for example. For example, for use in a vehicle, the input interface can be connectable to a bus system of the vehicle so that information from all subscribers of this bus system can be monitored, subscribed to or specifically accessed.

A plurality of control functions is provided. Each respective control function is designed to determine, from an input which has been read in, output data for the receiving device. Such output data can, for example, be a control signal for the receiving device, for example an actuator. A self-check logic unit is now provided for each control function, the logic unit being designed to detect a malfunction of said control function. For example, for the purposes of this detection, the self-check logic unit can, in particular, use the input provided to the respective control function, internal information of said control function, and/or output data determined by the respective control function. Furthermore, information relating to each control function is fed into at least one cross-check logic unit.

For example, an implausible or invalid input may indicate that a sensor used to detect this input or a communication link to said sensor is not working. For example, an internal state monitoring of the control function may refer to physical measured variables such as an operating voltage, a current draw, or a temperature of the control function. However, internal state monitoring may also include, for example, a “watchdog” that determines whether the control function may be stuck in an endless loop or in a comparable state in which it ceases to react. For example, the output data may be checked to see if they are within an allowable range of values.

Furthermore, at least one cross-check logic unit is provided. This cross-check logic unit is designed to check whether a by a control function is consistent with
output data determined by another control function,
internal information from this other control function; and/or
an input used by this other control function

In this way, the diagnostic coverage level can be significantly improved with respect to random hardware failures as well as failures of a systematic nature. In particular, the term “consistent with” means that not only can information of the same dimension (i.e., location coordinates with location coordinates) be matched or otherwise plausibility-checked, but so can information of different dimensions, such as location coordinates with acceleration measured values. Furthermore, this term also suggests that the quantities to be matched together need not be delivered with as precise synchrony as when comparing nominally identical data with the same dimension. For example, different algorithms with which raw data concerning one and the same traffic situation is processed may take different amounts of time to execute.

At least one output interface for output data is provided, the output interface being able to be connected to the receiving device. A changeover logic unit is also provided. This changeover logic unit is designed to switch output data determined by one or more of the control functions to the output interface on the basis of the findings of the self-check logic units and the findings of the at least one cross-check logic unit. The receiving device need not be part of the control system itself, but the output data may be guided out of the control system to the receiving device.

In this respect, the terms “interface” and “logic unit” are not to be limited in their understanding such that, for example, a changeover logic unit or an interface must always be implemented as a separate hardware unit. Rather, these terms are merely to be understood such that the respective functionality required must be provided in some way. For example, a changeover logic unit may also be fully or partially integrated into the respective control functions.

It was found that by the combining the self-check logic units and the cross-check logic units, the increase in the level of diagnostic coverage with respect to malfunctions produced
less redundancy and thus a cost saving,
more effective detection and handling of systematic errors and random hardware errors, and
higher performance, since, for example in comparison to a purely fully-redundant execution of the control functions with majority decision, no hard synchronization of redundant channels is required any longer.

Thus, the control system can make due with fewer control functions compared to merely performing the control functions fully redundantly, and it can have a comparatively lower probability of an adverse event (i.e., an un-intercepted malfunction). For example, a level of reliability that was previously only achievable with three fully-redundant control functions can now also be achieved with only two control functions. Overall, the expansion of monitoring to include the combination of self-check logic units and a cross-check logic unit involves less hardware expense and less cost than the addition of a third fully-redundant control function. Complex control functions can require expensive hardware platforms that include, for example, high-power microprocessors and/or hardware accelerators such as graphics processing units (GPUs).

For example, the control functions may be nominally identical. However, in a particularly advantageous embodiment, these different control functions
are designed to process the input provided to them into output data in different ways, and/or
are implemented on independent hardware platforms.
   In this way, the diagnostic coverage level can be further improved via diversity between the control functions. For example, random hardware errors (such as rollover of individual bits in registers or in memory) during processing of the inputs into state data and output data will be highly likely differently on different paths, and this will allow them to be identified. Also, it is highly likely that systematic errors, such as integer overflows, will not occur at exactly the same location in two differently implemented control functions. The same applies, accordingly, with regard to systematic errors in hardware platforms.

In another advantageous embodiment, the self-check logic units and the cross-check logic units are implemented on hardware having a higher quality class with respect to functional safety than the control functions. In particular, the quality class may manifest itself in the presence or absence of, for example, a relevant safety certification such as a particular ASIL level. In this way, efficient and cost-effective hardware can be used for the control function without any relevant compromises in terms of functional safety.

High performance and high quality in terms of functional safety are goals that are to some extent contradictory. For example, high performance is often achieved precisely by pushing the boundaries of the structure sizes of processors and other semiconductor components and selecting the clock rates just high enough to still stay within the thermal budget. However, such measures are detrimental to functional safety, because for small structure sizes, for example, external disruptions, such as by background radiation or electromagnetic interference, require significantly less energy to, for example, roll over a bit. Thus, the probability of this happening in a given operating environment is increased in the case of smaller structure sizes.

Hardware components that have both high performance and a high quality class in terms of functional safety are thus more expensive to manufacture and disproportionately expensive. The combination of the self-check logic units with the cross-check logic units results in a level of diagnostic coverage with respect to malfunctions in the control functions that is high enough to achieve the required overall safety in the generating of output data even if the control functions have a lower safety integrity level than the overall system. On the other hand, the self-check logic units and the cross-check logic units are relatively simple and can therefore be implemented with a reasonable degree of effort in hardware of a high quality class in terms of functional safety.

In another advantageous embodiment, to a plurality of control functions, different input interfaces are assigned, the interfaces being designed to read in incongruent inputs. In this way, diversity of inputs is also achieved. An error in an input, such as that which can arise from a malfunction of a sensor, will then affect the plurality of control functions in different ways, since this error is combined with different compositions of other inputs, respectively. The more disjunctive the inputs used by different control functions are, the less likely it is that the failure of a particular input simultaneously prevents or distorts the generation of output data in a plurality of control functions.

Random and systematic errors can be rectified so as to increase the safety-directed availability of the technical system, without having to interrupt the operation of the technical system which contains, for example, an actuator to be controlled. Thus, in another particularly advantageous embodiment, at least one self-check logic unit or cross-check logic unit, in response to the finding that a control function is malfunctioning, is designed to initiate
a recalculation of the output data in this control function,
a reconfiguration of this control function, and/or
a restarting of this control function.
   Alternatively or in combination with this, the incorrectly-operating control function can be inhibited. That is to say it may be prevented from forwarding its determined output data to the output interface. This can be realized, for example, using the changeover logic unit, but also, for example, in the control function itself or also by interrupting a communication link between the incorrectly-operating control function and a network comprising the downstream systems to be controlled.

In another particularly advantageous embodiment, at least one control function is designed to determine output data within the scope of a full range of functions of a technical system to which the actuator belongs. At the same time, both this control function and at least one other control function are designed to determine output data within the scope of a range of functions which has been degraded from the full range of functions. In this context, “degraded” may mean, for example, that an available variety of functions and/or a quantitative performance of the technical system is reduced compared to the full range of functions. For example, if the control system is used to control at least one actuator in a vehicle driven at least partially automated, a degraded range of functions may include the vehicle only being able to continue driving at a reduced speed or only being able to carry out certain driving maneuvers.

If the other control function is only provided to determine output data within the scope of the degraded range of functions, but not to determine output data within the scope of the full range of functions, this other control function can be implemented on, for example, a simpler hardware platform. The complete hardware equipment required to provide the full range of functions only has to be provided once and not several times, as in a fully redundant design.

Therefore, the control function with full hardware equipment provided to determine the output data within the scope of the full range of functions can be used in normal operation, for example. This control function can include, for example, high-power microprocessors and/or hardware accelerators, such as GPUs, and can be designed to, for example, extensively evaluate images captured in a vehicle environment using neural networks. In the event of a malfunction of this control function, the output data can be acquired by another control function that is only designed to transition the vehicle to a safe state using reduced driving maneuvers.

Thus, the existing hardware equipment is optimally utilized and for the majority of the operating time there is no complete hardware equipment lying idle.

In particular, there is a plurality of other control functions that can be used, for example, which allow different gradations of degraded operation, for example. For example, one other control function can be provided for operating the vehicle at reduced speed and another control function can be provided for stopping the vehicle at the next suitable parking location.

The invention also relates to a method for operating the previously described control system, specifically in the application case of an automated-driven vehicle to which the actuator to be controlled belongs. As described above, a first control function determines output data within the scope of the full range of functions for automated driving. At least one other control function is responsible for determining output data within the scope of a degraded range of functions.

In the context of the method, the self-check logic units and the cross-check logic units check whether this first control function or another control function is malfunctioning.

In response to the finding that none of the control functions are malfunctioning, the output data determined by the first control function within the scope of the full range of functions are output to the actuator.

In response to the finding that the first control function is malfunctioning, the output data determined by the other control function within the scope of the degraded range of functions are output to the actuator.

In response to the finding that the other control function is malfunctioning, the first control function is prompted to determine output data within the scope of the degraded range of functions and to output these new output data to the actuator.

Purely technically, in the event of a failure of the second control function, the vehicle could still drive using the first control function within the scope of the full range of functions. However, the failure of the second control function results in the necessary fallback level no longer being available in the event that an error in the first control function now also occurs. Therefore, after the failure of the second control function, continued operation of the first control function with the full range of functions is no longer permitted due to safety concerns.

Thus, in a particularly advantageous embodiment, a degraded range of functions is selected for the driving operation of the vehicle, said range requiring a lower safety integrity level than the full range of functions would require. In particular, for example, operation in the degraded range of functions may require a level of safety integrity that is low enough such that operation of only the first control function without other fallback levels is sufficient.

For example, as explained above, the degraded range of functions can include, in particular, that
the maximum driving speed of the vehicle is reduced relative to the full range of functions; and/or
the vehicle, if on a previously planned emergency stop trajectory, is brought to a standstill; and/or
the vehicle is removed from public traffic at the next opportunity in a normal manner with respect to traffic.

The reduction of the driving speed can already result in a lower safety integrity level being sufficient, i.e., continued driving is only permitted using the first control function. Stopping on the emergency stop trajectory and otherwise removal from public traffic, for example by parking in the next parking space, requires an even lower level of safety integrity, and also only requires a short time. Thus, this maneuver can be performed with only one remaining control function.

The method can in particular be computer-implemented as a whole or in part. The invention therefore also relates to a computer program including machine-readable instructions which, when executed on one or more computers, cause the computer(s) to perform the described method. In this sense, control devices for vehicles and embedded systems for technical devices that are likewise capable of executing machine-readable instructions are also to be regarded as computers.

Likewise the invention also relates to a machine-readable data carrier and/or to a download product comprising said computer program. A download product is a digital product that can be transmitted via a data network, i.e. can be downloaded by a user of the data network, and can be offered for sale in an online shop for immediate download, for example.

A computer can moreover be equipped with the computer program, with the machine-readable data carrier or with the download product.

Further measures improving the invention are shown in more detail below, together with the description of the preferred exemplary embodiments of the invention, with reference to the figures.

### EXEMPLARY EMBODIMENTS

The figures show:

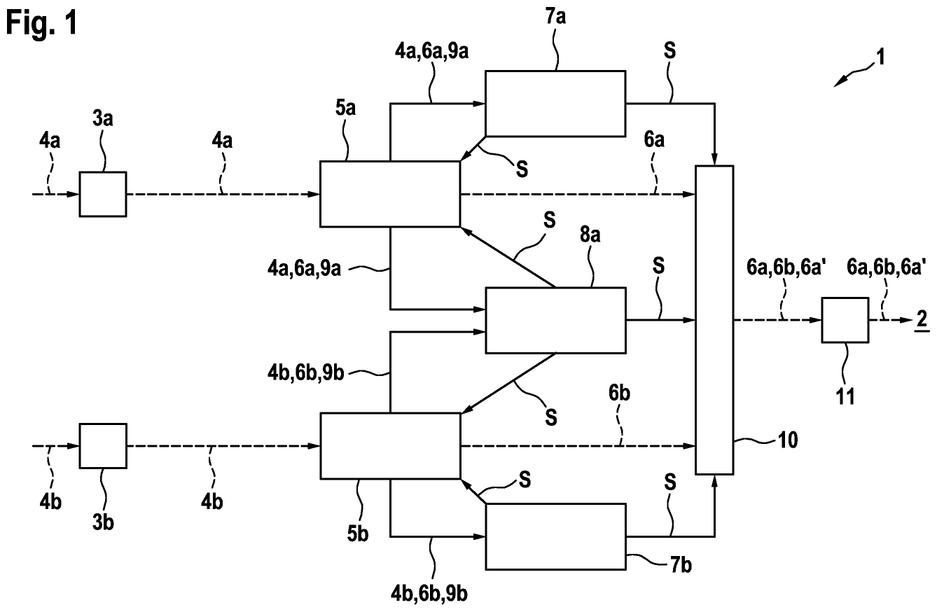

FIG. 1 An exemplary embodiment of the control system 1 with two control functions 5a-5b;

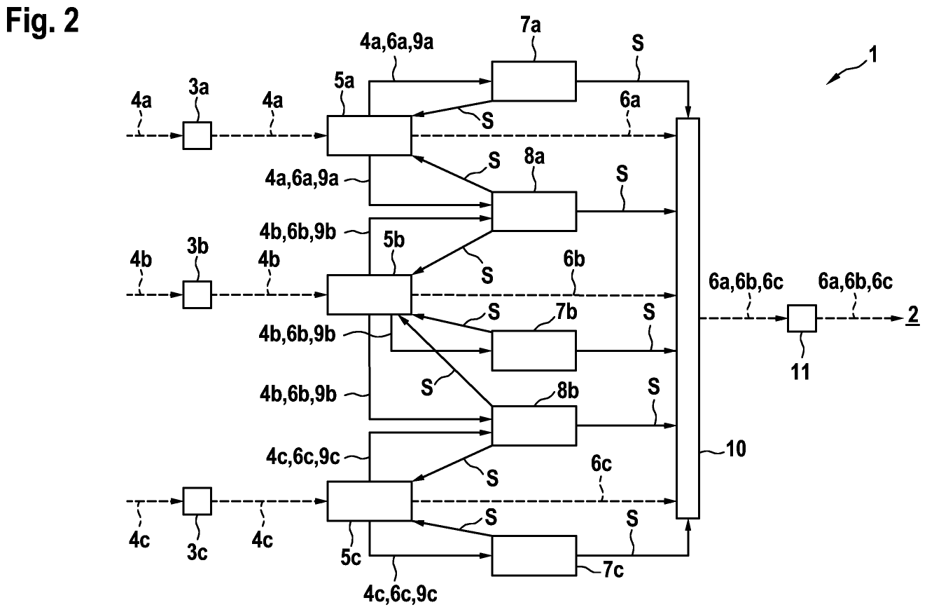

FIG. 2 An exemplary embodiment of the control system 1 with three control functions 5a-5c;

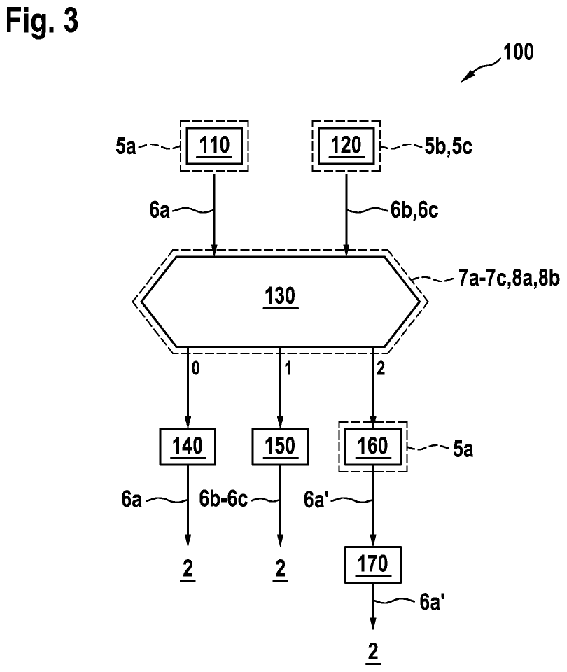

FIG. 3 An exemplary embodiment of the method 100 for operating a control system 1.

FIG. 1 is a schematic drawing of a first exemplary embodiment of the control system 1. This control system 1 contains a first control function 5a and a second control function 5b. The first control function 5a receives an input 4a via at least a first input interface 3a. The second control function 5b receives an input 4b via a second input interface 3b.

The first control function 5a is designed and equipped to determine first output data 6a within the scope of the full range of functions of the technical system containing the one actuator or containing another downstream system as the receiving device 2. The second control function 5b is only designed and equipped to determine second output data 6b within the scope of a degraded range of functions. Each of the control functions 5a, 5b is monitored by a respective self-check logic unit 7a, 7b which uses the respective input 4a or 4b, the respective output data generated 6a or 6b, as well as internal information 9a, 9b from the respective control function 5a, 5b. In addition, information 4a, 6a, 9a and 4b, 6b, 9b relating to control functions 5a and 5b, respectively, is also transmitted to the cross-check logic unit 8a.

In the interplay of the self-check logic units 7a, 7b and the cross-check logic unit 8a, it is checked whether both control functions 5a, 5b are functioning without error. Depending on the respective findings, it is determined via the changeover logic unit 10 which output data are output to the actuator or the downstream system 2 via the output interface 11.

If both control functions 5a, 5b are functioning without error, in the example shown in FIG. 1 the first output data 6a are output to the actuator or the downstream system 2 so that the actuator or the downstream system 2 is controlled within the scope of the full range of functions.

If the control function 5a is malfunctioning, the second output data 6b are output to the actuator or the downstream system 2 so that the actuator or the downstream system 2 is controlled within the scope of the degraded range of functions.

If the control function 5b is malfunctioning, the first control function 5a is prompted to determine new output data 6a′ within the scope of the degraded range of functions. These new output data 6a′ are then output to the actuator or the downstream system 2. As explained above, this puts into effect the specification from the application that the full range of functions may only be used if the second control function 5b is available as the fallback level.

All influence that the control logic units 7a, 7b, 8a have on which output data 6a, 6b, 6a′ are output to the actuator or the downstream system 2 or are specifically newly generated for this purpose occurs via safety instructions S.

FIG. 2 is a schematic drawing of another exemplary embodiment of the control system 1. In contrast to FIG. 1, a third control function 5c is also provided. This third control function 5c receives an input 4c via a third input interface 3a and determines output data 6c. The input 4c, the output data 6c, and/or internal information 9c of the third control function 5c are fed into the third self-check logic unit 7c as well as into a second cross-check logic unit 8b. This second cross-check logic unit 8b also receives the information 4b, 6b and 9b relating to the second control function 5b.

In the example shown in FIG. 2, the first control function 5a is designed and equipped to determine first output data 6a within the scope of the full range of functions of the technical system containing the actuator or the downstream system 2. The second control function 5b is designed and equipped to determine second output data 6b within the scope of a first degraded range of the technical system. The third control function 5c is designed and equipped to determine third output data 6c within the scope of an even further limited second degraded range of functions of the technical system.

Since three control functions 5a-5c are now present, the first control function 5a no longer has to additionally be designed to also determine on demand, if necessary, new output data 6a′ within the scope of the degraded range of functions. Rather, if only one of the control functions 5b or 5c fails, the other control function 5c or 5b is still available as a fallback level, respectively. If the first control function 5a is functioning without error, it can continue to be operated in its full range of functions.

FIG. 3 is an exemplary embodiment of the method 100 for operating a control system 1. This exemplary embodiment corresponds to the mode of operation already explained in connection with FIG. 1.

In step 110, output data 6a are generated by a first control function 5a, the data providing the full range of functionality for automated driving of the vehicle.

In step 120, output data 6b-6c are generated by another control function 5b-5c, the data providing a degraded range of functionality for automated driving of the vehicle.

In step 130, using the self-check logic units 7a-7c and the cross-check logic units 8a, 8b, it is checked whether this first control function 5a or another control function 5b-5c is malfunctioning.

If none of the control functions 5a-5c are malfunctioning (result 0), the output data 6a determined by the first control function 5a are output to the actuator or the downstream system 2 in step 140.

If the first control function 5a is malfunctioning (result 1), the output data 6b-6c determined by the other control function 5b-5c are output to the actuator or the downstream system 2 in step 150.

If the other control function 5b-5c is malfunctioning (result 2), the first control function 5a is prompted to determine output data 6a′ within the scope of the degraded range of functions in step 160. These output data 6a′ are then output to the actuator or the downstream system 2 in step 170.

1. A control system for at least one receiving device, comprising:
at least one input interface configured to read in an input to be reacted to by controlling the receiving device;
a plurality of control functions, each of which is configured to determine output data for the receiving device from the input which has been read in;
a self-check logic unit for each control function, the self-check logic unit configured to detect a malfunction of each control function;
at least one cross-check logic unit configured to check whether output data determined by a control function of the plurality of control functions are consistent with (i) output data determined by another control function of the plurality of control functions, (ii) internal information from the other control function, and/or (iii) the input used by the other control function, wherein information relating to each control function of the plurality of control functions is fed into the at least one cross-check logic unit;
at least one output interface configured to output data, the at least one output interface operably connected to an actuator; and
a changeover logic unit configured to switch the output data determined by one or more of the control functions to the at least one output interface based on findings of the self-check logic units and findings of the at least one cross-check logic unit.

2. The control system according to claim 1, wherein:
different input interfaces of the at least one input interface are assigned to the plurality of control functions, and
the different input interfaces are configured to read in incongruent inputs.

3. The control system according to claim 1, wherein different control functions of the plurality of control functions (i) are configured to process the input in different ways to determine the output data, and/or (ii) are implemented on independent hardware platforms.

4. The control system according to claim 1, wherein the self-check logic units and the at least one cross-check logic unit are implemented on hardware that has a higher quality class with respect to functional safety than the control functions of the plurality of control functions.

5. The control system according to claim 1, wherein at least one of the self-check logic units or the at least one cross-check logic unit, in response to finding that a control function of the plurality of control functions is malfunctioning, is configured to:
initiate a recalculation of the output data in the control function,
initiate a reconfiguration of the control function,
initiate a restarting of the control function, and/or
inhibit the control function.

6. The control system according to claim 1, wherein:
at least one control function of the plurality of control functions is configured to determine the output data within a scope of a full range of functions of a technical system to which the actuator belongs, and
the at least one control function and at least one other control function of the plurality of control functions are configured to determine the output data within a scope of a range of functions which are degraded from the full range of functions.

7. The control system according to claim 1, the actuator is included in a vehicle driven in an least partially automated manner.

8. A method for operating a control system for at least one receiving device, comprising:
reading in an input with at least one input interface, the input configured to be reacted to by controlling the receiving device;
generating output data by a first control function of a plurality of control functions, each control function configured to determine corresponding output data for the receiving device from the input which has been read in, and the output data providing a full range of functionality for automated driving of a vehicle;
generating output data by another control function of the plurality of functions, the output data providing a degraded range of functionality for the automated driving of the vehicle;
using self-check logic units and cross-check logic units to check when the first control function or the other control function is malfunctioning, wherein a self-check logic unit is provided for each control function;
in response to finding that none of the control functions of the plurality of control functions are malfunctioning, outputting the output data determined by the first control function to an actuator of the vehicle;
in response to finding that the first control function is malfunctioning, outputting the output data determined by the other control function to the actuator;
in response to finding that the other control function is malfunctioning, the first control function is prompted to determine additional output data within a scope of a degraded range of functions, and the additional output data are output to the actuator,
wherein the at least one cross-check logic unit is configured to check whether the output data determined by the first control function are consistent with (i) the output data determined by the other control function, (ii) internal information from the other control function, and/or (iii) the input used by the other control function, wherein information relating to each control function of the plurality of control functions is fed into the at least one cross-check logic unit.

9. The method according to claim 8, further comprising:
selecting a degraded range of functions for driving the vehicle, the degraded range of functions requiring a lower level of safety integrity than a full range of functions.

10. The method according to claim 9, wherein in the degraded range of functions:
a maximum driving speed of the vehicle is reduced relative to the full range of functions;
the vehicle, when on a previously planned emergency stop trajectory, is brought to a standstill; and/or
the vehicle is removed from public traffic at a next opportunity in a normal manner with respect to traffic.

11. The method according to claim 8, wherein a computer program contains machine-readable instructions which, when executed on one or more computers, cause the computer or computers to carry out the method.

12. The method according to claim 11, wherein a non-transitory machine-readable storage medium and/or download product includes the computer program.

13. (canceled)
